(19) United States
(12) Patent Application Publication
(10) Pub. No.: US 2004/0158443 A1
(43) Pub. Date: Aug. 12, 2004

(54) Functional verification using heterogeneous simulators

(75) Inventor: Raghuraman Rajanarayanan, Vadapalani Chennai (IN)

Correspondence Address: TEXAS INSTRUMENTS INCORPORATED, P O BOX 655474, M/S 3999, DALLAS, TX, 75265

(73) Assignee: Texas Instruments Incorporated, Dallas, TX (US)

(21) Appl. No.: 10/361,774

(22) Filed: Feb. 11, 2003

(51) Int. Cl. G06F 7/60; G06F 17/10

(52) U.S. Cl. 703/2; 703/5

(57) ABSTRACT

A master scheduler which interfaces with several heterogenous simulators simulating individual modules of an integrated circuit. The master scheduler receives data indicating the modules assigned to each simulator and the interconnections of the modules. The master scheduler forwards output signals generated by one simulator to any other simulators as specified by the interconnection data. As a result, functional verification of an entire integrated circuit can be performed even if only portions can be simulated by corresponding simulators.

### BACKGROUND OF THE INVENTION

1. Field of the Invention

The present invention relates to testing of integrated circuits, and more specifically to a method and apparatus for functional verification using heterogeneous simulators simulating different modules of an integrated circuit.

2. Related Art

Functional verification generally refers to determining whether an integrated circuit generates a desired output value in response to corresponding input values. In a typical design cycle, input values are evaluated based on digital representation of an integrated circuit, and the corresponding output values are examined to verify whether the integrated circuit generates the desired values. Such verification is commonly referred to as simulation.

One challenge presented in functional verification of integrated circuits is that different modules (portions) of an integrated circuit are implemented using different tools/languages, and simulators may be present to simulate only the corresponding module in isolation. In other words, as each of such simulators (“heterogeneous simulators”) may operate only in isolation, it may not be possible to perform functional verification of the entire integrated circuit. It may be desirable to perform functional verification of the entire integrated circuit.

### SUMMARY OF THE INVENTION

The present invention enables functional verification of an integrated circuit, even if the modules (contained in the integrated circuit) can be simulated only by heterogenous simulators. A master scheduler provided according to an aspect of the present invention receives data representing assignment of each module to a corresponding heterogenous simulator and an interconnection of the modules. The master schedule forwards signal elements received from one simulator to the other simulators according to the interconnection data.

According to another aspect of the present invention, master scheduler may determine a step time and suspend the operation of each heterogenous simulator after simulating the step time. The operation of the simulators is resumed after all of the heterogenous simulators complete simulating the step time and after the signal elements are forwarded according to the interconnection data. In an embodiment, the step time is set equal to a highest common factor of a longest time taken by each of the modules to generate a corresponding output value based on a corresponding set of input values.

In another embodiment, the master scheduler stores the signal element along with an associated integrated circuit time at which the signal element is generated. The signal element is forwarded to the second simulator when the second simulator reaches the associated integrated circuit time. The operation of the second simulator is suspended only if the signal element is not generated when the second simulator reaches the associated integrated circuit time.

In an embodiment, the interconnection data specifies a specific module to which an output signal generated by an another module is to be provided. In an implementation, the heterogenous simulators comprise a VHDL simulator, a Verilog simulator and an analog simulator.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings briefly described below.

Figure (FIG.) 1 is a block diagram illustrating a functional verification system in an embodiment of the present invention.

FIG. 2 is a flowchart illustrating the operation of a master scheduler in an embodiment of the present invention.

FIG. 3 is a block diagram illustrating an example integrated circuit, the functional verification of which can be performed according to an aspect of the present invention.

FIG. 4 depicts a table illustrating the manner in which interconnection data may be formed.

FIG. 5 is a flowchart illustrating in further detail the operation of a master scheduler in an embodiment of the present invention.

FIG. 6 is a block diagram illustrating the details of an embodiment of a master scheduler illustrated using software instructions.

### DETAILED DESCRIPTION OF THE PREFERRED EMBODIMENTS

1. Overview and Discussion of the Invention

An aspect of the present invention enables a master scheduler to be associated with heterogeneous simulators verifying different modules of an integrated circuit. The master scheduler may receive data indicating assignment of each module to a specific simulator and the interconnections of the modules. The master scheduler coordinates signal (data) transfer between the modules while performing simulation of an integrated circuit. In other words, the master scheduler receives a signal element from a module and transfers the signal element to other modules according to the interconnections.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Functional Verification System

FIG. 1 is a block diagram illustrating the operation of functional verification system 100 in an embodiment of the present invention. Functional verification system 100 is shown containing VHDL simulator 110, Verilog simulator 120, analog simulator 130 and master scheduler 150. Each component is described below.

For illustration, an integrated circuit is assumed to contain three interconnected modules—a VHDL module, a Verilog module and an analog module. Each of the three simulators 110, 120 and 130 are assumed to be designed to simulate a corresponding one of the three modules. As described below, master scheduler 150 enables the entire integrated circuit to be simulated by coordinating the operation of the three simulators 110, 120 and 130.

VHDL simulator 110 is designed to simulate VHDL modules. The inputs necessary for such simulation may be received on paths 151 (from verification of other modules) and/or 111 (external inputs, e.g., provided by a user). The external inputs are hereafter referred to as primary inputs and the input signals received from other modules are referred to as secondary inputs. The outputs generated may be provided on paths 115 (to other modules) and/or 119 (outputs of the integrated circuit). An embodiment of VHDL simulator 10 may be implemented using Modelsim™ simulator, available from Mentor Graphics, Inc., Oregon, USA.

Similarly, Verilog simulator 120 is designed to simulate Verilog modules. The inputs may be received on paths 152 (secondary inputs) and/or 121 (primary inputs), and outputs may be generated on paths 125 and/or 129. Analog simulator 130 simulates analog modules. The inputs may be received on paths 153 and/or 131, and outputs may be generated on paths 135 and/or 139.

In an embodiment, Verilog simulator 120 and analog simulator 130 are respectively implemented using NC-Verilog™ simulator (available from Cadence Corporation of California, USA) and TISpice3 simulator (available from Texas Instruments, Inc., the assignee of the subject patent application). In general, the three simulators 110, 120, and 130 represent examples of heterogenous simulators.

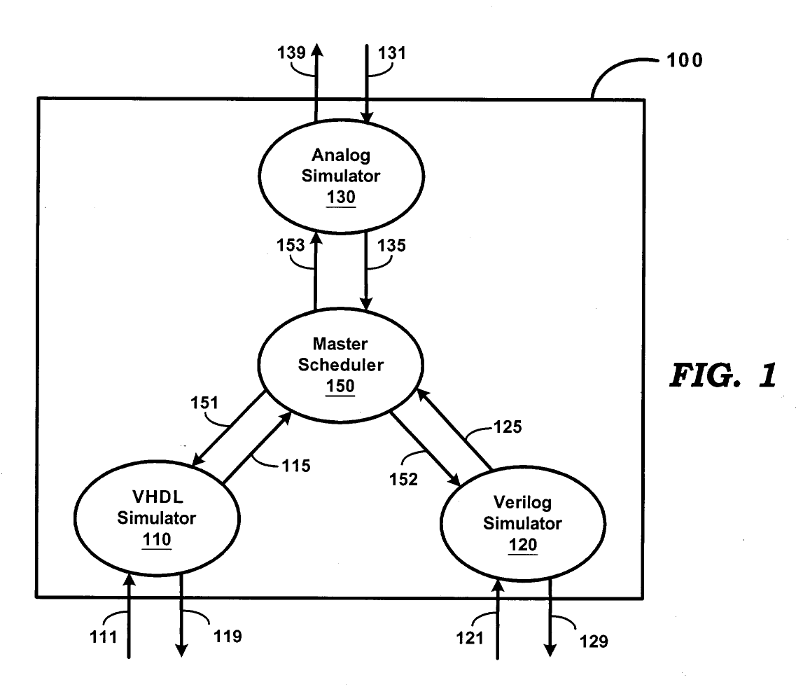

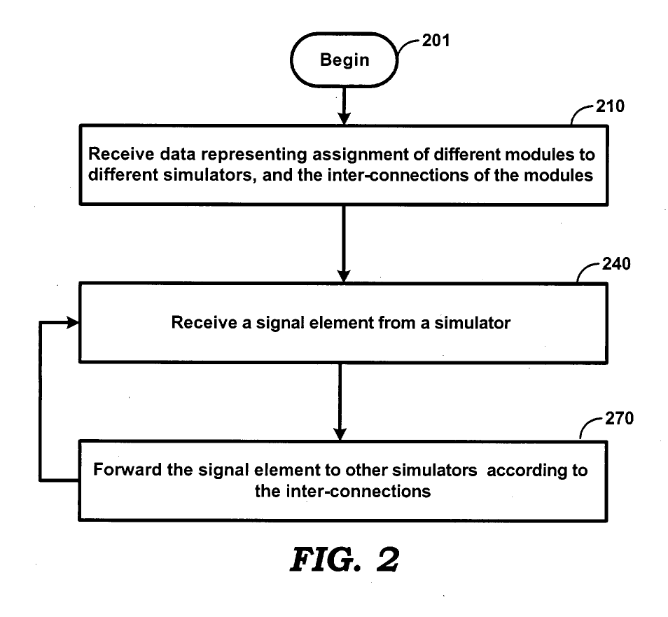

Master scheduler 150 coordinates the transfer of various signals between heterogenous simulators such that an entire integrated circuit can be simulated. The manner in which such a feature may be provided is described below with reference to FIG. 2.

3. Method

FIG. 2 is a flowchart illustrating a method by which a master scheduler may coordinate the transfer of various signals generated by heterogeneous simulators (with each simulator having the ability to simulate only a module) such that an entire integrated circuit can be simulated. The method is described with reference to FIG. 1 for illustration. However, the method can be implemented in other embodiments without departing from the scope and spirit of the present invention, as will be apparent to one skilled in the relevant arts based on the disclosure provided herein. The method begins in step 201 in which control passes to step 210.

In step 210, master scheduler 150 receives data which represents assignment of different modules (of an integrated circuit) to different simulators and the interconnections of the modules. For example, an integrated circuit may be formed by three modules, respectively represented by VHDL, Verilog and transistor level designs. Accordingly, the three modules may respectively be assigned to VHDL simulator 110, Verilog simulator 120 and analog simulator 130.

The data representing interconnections indicates which of the input/output paths of different modules form the same physical path of the integrated circuit. For example, if three modules are connected by a bus, the interconnections data indicates that the respective path of the three modules in fact is a part of the same bus. The interconnections data thus represents the specific paths (to other modules) on which an output generated by a module is to be forwarded.

In step 240, master scheduler 150 receives a signal element from one of the simulators 110, 120, and 130. The signal element is generated by the simulator while simulating the corresponding assigned module, and forwarded on a path as specified by the design logic of the module. Master scheduler 150 receives the signal element on the corresponding path.

In step 270, the signal element is forwarded to other modules of an integrated circuit according to the interconnections. The other modules may continue simulation after receiving the signal element as a secondary input signal. As noted above, data representing the interconnections is received in step 210. The method ends in step 299.

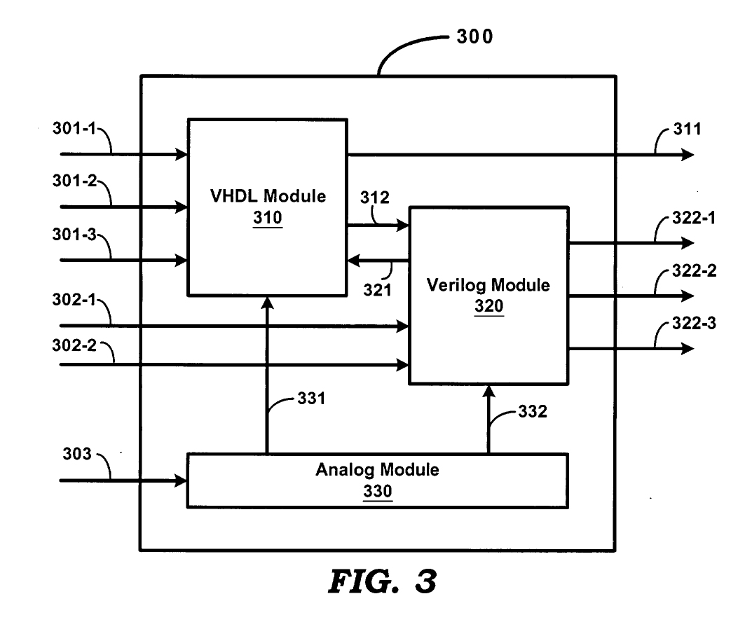

Steps 240 and 270 may be repeated until the integrated circuit is simulated to the satisfaction of a user. The manner in which each of the above steps can be implemented is described below with examples for illustration. First, an example circuit, which is used for such illustration, is described with reference FIG. 3.

4. Example Circuit

FIG. 3 is a block diagram illustrating the logical view of an example integrated circuit which can be verified according to an aspect of the present invention. Integrated circuit 300 is shown containing three modules—VHDL module 310, Verilog module 320 and analog module 330. Each module in turn may contain several modules, designed using the same language. While the description is provided with reference to only three modules for illustration, an integrated circuit may contain more modules, generally depending on the number of languages used to represent all the modules sought to be simulated.

VHDL module 310 is shown receiving secondary inputs 331 and 321 from analog module 330 and verilog module 320 respectively, and primary inputs on paths 301-1 through 301-3. VHDL module 310 generates output on paths 311 and 312 according to the received inputs. VHDL module 310 may be implemented in RTL, which can be simulated using Modelsim™ simulator

Verilog module 320 is shown receiving secondary inputs 332 and 312 from analog module 330 and VHDL module 310 respectively, and primary inputs on paths 302-1 and 302-2. Verilog module 320 generates output on paths 321 and 322-1 through 322-3 according to the received inputs. Verilog module 320 may be implemented in gate level, which can be simulated using NC-Verilog™ simulator

Analog module 330 is shown receiving only primary input on path 303 and generates output on paths 331 and 332 according to the received input. Analog module 330 is assumed to be implemented in transistor level, which can be simulated using TISpice3™ simulator. As analog module 330 is not receiving secondary inputs from other modules, the module may be termed as being independent, while VHDL module 310 and verilog module 320 are termed as dependent modules.

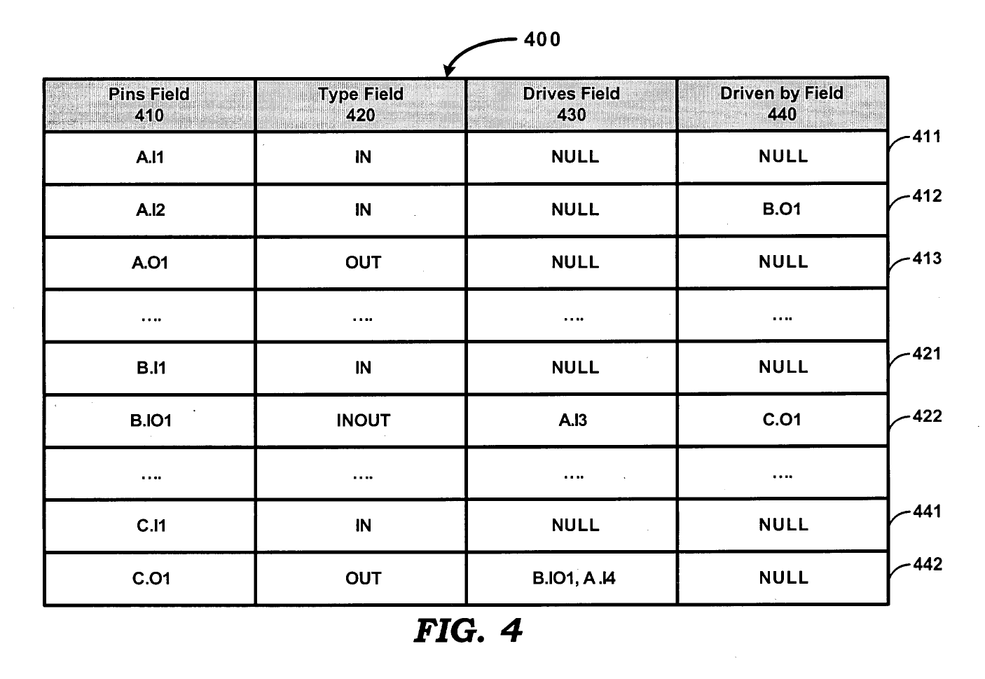

As noted above, master scheduler 150 is provided data representing interconnections (or dependencies). A logical view of such data for integrated circuit 300 is described below with reference to FIG. 4.

5. Interconnections Data

FIG. 4 contains table 400 illustrating the details of interconnections of modules of integrated circuit 300. Table 400 illustrates the connectivity details of modules 310, 320 and 330 of integrated circuit 300. Table 400 is shown containing four columns—pins field 410, type field 420, drives field 430 and driven by field 440. Each field is described below. In the description below, modules 310, 320 and 330 are respectively represented by A, B, and C for conciseness.

Pins field 410 indicates the name of a pin. According to the convention employed, the name of the pin contains the module name, direction of the pin and pin number. For example, in pin name ‘A.1’ of row 411, ‘A’ indicates that the pin is on VHDL module 310, ‘I’ indicates the pin as input type, and ‘1’ indicates the pin as the first pin. Thus, pin A.I1 represents pin number 1 (e.g., receiving primary input on path 301-1) in module 310 and receives an input.

Similarly, the pin (driving both paths 331 and 332) of row 442 is shown represented by C.O1, indicates that the pin is pin number 1 in analog module 330 and is of output type. A pin type of ‘IO’ (e.g., in row 422) indicates that the pin is a bidirectional pin (connected to paths 321 and 332). Type field 420 more expressly contains the pin type (input, output or bidirectional).

Drives field 430 indicates the name of the pins that are to be driven by the corresponding pin in pins field 410. For example, row 442 indicates that pin C.O1 provides input signals to pins B.IO1 and A.I4.

Driven by field 440 indicates the name of the pin that drives the corresponding pin in pins field 410. For example, row 422 indicates that pin B.IO1 is driven by C.O1. It may be noted that driven by field 440 needs to correspond to drives field 430. Thus, row 442 indicates that pin C.O1 drives pin BIO1 (consistent with the information in row 422).

A ‘NULL’ entry for a pin implies that the pin is not connected to any other pin in the corresponding direction (i.e., input or output). In the case of an input pin (e.g, pin C.I1 of row 441), the pin accepts a primary input if driven by field 440 contains ‘NULL’. Pins providing primary outputs contain a NULL value in drives fields 430.

Thus, table 400 contains the information necessary to forward signals generated by one module to other modules as necessary according to the design of the corresponding integrated circuit. It should be understood that the data of table 400 can be generated by examination of the design of the integrated circuit and can be generated in a known way.

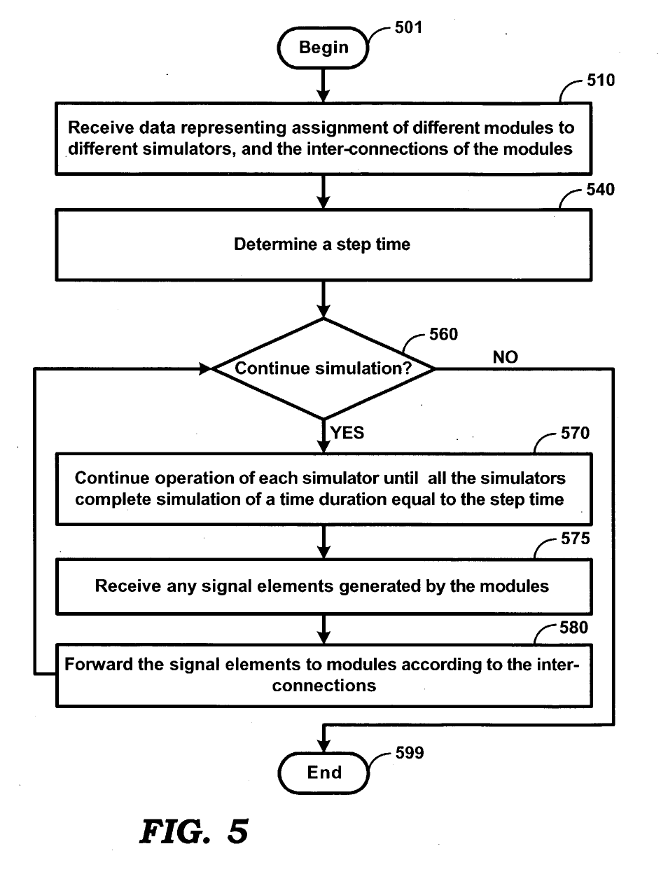

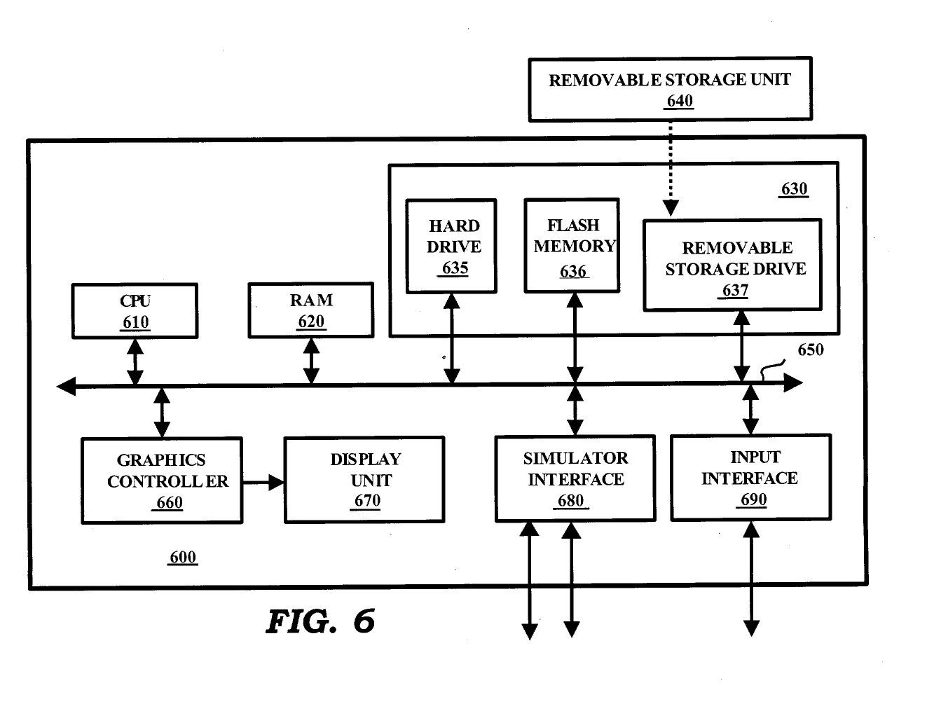

Master scheduler 150 receives table 400 and coordinates the transfer of signals according to the data in the table. One problem which may need to be addressed in the design of master scheduler 150 (functional verification system 100 in general) is that each simulator may operate at different speeds, and may thus require inputs and generate outputs according to corresponding speeds. An example implementation of master scheduler 150 which addresses such a problem is described below with reference to FIGS. 5 and 6.

6. Master Scheduler

FIG. 5 is a flowchart illustrating the operation of master scheduler 150 in an embodiment. The flowchart is described with reference to FIG. 3 for illustration. However, the method can be implemented in other embodiments as will be apparent to one skilled in the relevant arts based on the disclosure provided herein. The method begins in step 501 in which control passes to step 510.

In step 510, master scheduler 150 receives data representing assignment of different modules to different simulators, and the inter-connections of the modules. For example, data representing table 400 of FIG. 4 may be received.

In step 540, master scheduler 150 determines a step time, representing a duration of time (measured with reference to chronological time when a physical/actual integrated circuit is operational) each block needs to be simulated in each step (described below). In an embodiment, master scheduler 150 may receive (or determine) a longest time each module may consume to generate a corresponding signal element during the operation of the corresponding integrated circuit. Such a longest time may equal the delay in a critical path and can be determined using suitable static timing analysis (STA) tool widely available in the market place.

The step time is then computed to equal the highest common factor of the longest times. For example, if the longest time periods of modules be 3.5 ns, 2.5 ns and 1 ns, then the step time equals 0.5 ns. By computing the step time as such, master scheduler 150 ensures that any output signals are available at an end of a step, and the signals may be propagated to the dependent modules at the beginning of the next step. As a result, all the output signals may be accurately captured and provided to dependent modules according to the interconnection data.

In step 560, master scheduler 150 determines whether to continue simulation for the next step duration. In general, simulation may be continued if all the simulators are operational and have completed simulation of the previous step duration. Control passes to step 570 if simulation is to be continued, or else to step 599. The flowchart ends in step 599.

In step 570, the operation of each simulator is continued until all the simulators complete simulation of a time duration equal to the step time on integrated circuit time scale (i.e., time scale assuming a physical/real integrated circuit is operational). In general, a module operating in actual/real operation takes different time duration to perform a task than when a simulator (simulating the module) performs the same task. The time consumed by a simulator may be referred to as a simulation time.

The simulation time of each module to simulate a step time on integrated circuit time scale may not be the same (due to reasons such as different processor speeds and program logic for different simulators). Accordingly, master scheduler 150 may suspend the operation of faster simulators until the slower simulators complete simulating the step time.

In an embodiment, each of simulators 110, 120 and 130 is designed to receive a time duration and perform simulation for that time duration. Accordingly, master scheduler 150 may configure each of the simulators with the step time, and assert another signal to cause resumption of simulation (in step 560) after all the simulators have simulated the step time and the output signals are forwarded according to the dependencies.

In step 575, master scheduler 150 receives any signal elements generated by the modules in a present step. In an embodiment, master scheduler 150 polls the simulators to determine whether any output signal is generated. Polling refers to strobing (examining) the output signal elements generated by modules that drive the inputs of other modules.

In step 580, the received signal elements are forwarded to modules according to the interconnections. Once the forwarding is complete, simulation for the next step may continue and accordingly control passes to step 560. The loop of steps 560, 570, 575 and 580 may be continued until the integrated circuit is simulated to a desired level/duration.

Thus, the approaches of above can be used to enable functional verification of integrated circuits using heterogeneous simulators simulating only modules of the integrated circuits. However, one problem with the approach of above is that the operation of faster simulators is suspended until the slower simulators complete simulation of the step time, even if the faster simulators do not need signals elements from other simulators to continue operation.

An alternative embodiment overcomes such a problem by enabling faster simulators to continue operation until prevented by data dependencies. In such an embodiment, master scheduler 150 receives the simulation time and the output signal elements from each simulator, converts the simulation time into corresponding integrated circuit time and stores the output signal elements and corresponding integrated circuit time. A linked list may be maintained for the signal elements received on each path/pin, with each element in the list storing the signal element and the corresponding integrated circuit time.

Master scheduler 150 provides a stored signal element to another simulator when the another simulator reaches the integrated circuit time. In such a case, the operation of each simulator may be suspended only as necessitated by data dependency, i.e., when another simulator has not generated a required signal element. In general, if a simulator requiring a signal element operates faster and reaches a time (on integrated circuit time scale, assuming normal operation of the integrated circuit) when the data is required, and if the simulator generating the signal element has not reached that time point, the operation of the simulator requiring the signal element may be suspended.

The increase (or continuation of measurement) of simulation time of such suspended simulators may also be stopped in the suspended phase of operation. As simulators are suspended only when necessitated by data dependencies, functional verification may be completed sooner. Thus, various embodiments of functional verification system 100 may be implemented using the approaches of above. In particular, master scheduler 150 may be implemented as a combination of one or more of hardware, firmware and software. The description is continued with reference to an implementation based on software.

7. Software Implementation

FIG. 6 is a block diagram illustrating the details of master scheduler 150 in an embodiment of the present invention. Even though computer system 600 is described with specific components and architecture for illustration, it should be understood that the present invention may be implemented in several other types of embodiments.

Computer system 600 may contain one or more processors such as central processing unit (CPU) 610, random access memory (RAM) 620, secondary memory 630, graphics controller 660, display unit 670, simulator interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single processing unit. RAM 620 may receive instructions from secondary memory 630 using communication path 650. Data indicating assignment of different modules to different simulators and the interconnections of the modules may be stored and retrieved from secondary memory 630 (and/or RAM 620) during the execution of the instructions.

Graphics controller 660 generates display signals (e.g., in RGB format) to display unit 670 based on data/instructions received from CPU 610. Display unit 670 contains a display screen to display the images defined by the display signals. Input interface 690 may correspond to a key-board and/or mouse, and generally enables a user to provide inputs. Simulator interface 680 provides the connectivity to various simulators simulating the corresponding modules, and thus used to receive/send various signal elements.

Secondary memory 630 may contain hard drive 635, flash memory 636 and removable storage drive 637. Secondary storage 630 may store the software instructions and data (e.g., interconnections of modules), which enable computer system 600 to provide several features in accordance with the present invention. Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable storage medium having stored therein computer software and/or data. An embodiment of the present invention is implemented using software running (that is, executing) in computer system 600.

In this document, the term “computer program product” is used to generally refer to removable storage unit 640 or hard disk installed in hard drive 635. These computer program products are means for providing software to computer system 600. An embodiment of the software is implemented based on Virtuoso Product Version 4.4.2 (along with Companion Tool developed by Segantec Corporation) available from Cadence Corporation (www.cadence.com).

As noted above, CPU 610 may retrieve the software instructions, and execute the instructions to provide various features of the present invention. The features of the present invention are described above in detail.

### 8. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of enabling functional verification of an integrated circuit, said integrated circuit comprising a plurality of modules, said method being performed in a master scheduler, said method comprising:
receiving data representing assignment of each of said plurality of modules to a corresponding one of a plurality of heterogenous simulators and an interconnection of said plurality of modules;
receiving a signal element from a first simulator comprised in said plurality of heterogenous simulators, wherein said signal element is generated by simulating a corresponding module assigned to said first simulator; and
forwarding said signal element to a second simulator according to said interconnection of said plurality of modules, wherein said second simulator is comprised in said plurality of heterogenous simulators.

2. The method of claim 1, wherein said interconnection specifies a specific module to which an output signal generated by an another module is to be provided, wherein said specific module and said another module are comprised in said plurality of modules.

3. The method of claim 1, wherein said plurality of heterogenous simulators comprise a VHDL simulator, a Verilog simulator and an analog simulator.

4. The method of claim 1, further comprising:
determining a step time; and
suspending the operation of each of said plurality of heterogenous simulators after simulating said step time.

5. The method of claim 4, further comprising resuming operation of all of said plurality of heterogenous simulators after all of said plurality of heterogenous simulators complete simulating said step time and after said forwarding.

6. The method of claim 5, wherein said step time comprises a highest common factor of a longest time taken by each of said plurality of modules to generate a corresponding output value based on a corresponding set of input values.

7. The method of claim 1, further comprising:
storing said signal element along with an associated integrated circuit time at which said signal element is generated, wherein said signal element is forwarded to said second simulator when said second simulator reaches said associated integrated circuit time.

8. The method of claim 7, further comprising:
suspending an operation of said second simulator if said signal element is not generated when said second simulator reaches said integrated circuit time.

9. A computer readable medium carrying one or more sequences of instructions for causing a master scheduler to enable functional verification of an integrated circuit, said integrated circuit comprising a plurality of modules, wherein execution of said one or more sequences of instructions by one or more processors contained in said master scheduler causes said one or more processors to perform the actions of:
receiving data representing assignment of each of said plurality of modules to a corresponding one of a plurality of heterogenous simulators and an interconnection of said plurality of modules;
receiving a signal element from a first simulator comprised in said plurality of heterogenous simulators, wherein said signal element is generated by simulating a corresponding module assigned to said first simulator; and
forwarding said signal element to a second simulator according to said interconnection of said plurality of modules, wherein said second simulator is comprised in said plurality of heterogenous simulators.

10. The computer readable medium of claim 9, wherein said interconnection specifies a specific module to which an output signal generated by an another module is to be provided, wherein said specific module and said another module are comprised in said plurality of modules.

11. The computer readable medium of claim 9, wherein said plurality of heterogenous simulators comprise a VHDL simulator, a Verilog simulator and an analog simulator.

12. The computer readable medium of claim 9, further comprising:
determining a step time; and
suspending the operation of each of said plurality of heterogenous simulators after simulating said step time.

13. The computer readable medium of claim 12, further comprising resuming operation of all of said plurality of heterogenous simulators after all of said plurality of heterogenous simulators complete simulating said step time and after said forwarding.

14. The computer readable medium of claim 13, wherein said step time comprises a highest common factor of a longest time taken by each of said plurality of modules to generate a corresponding output value based on a corresponding set of input values.

15. The computer readable medium of claim 9, further comprising:
storing said signal element along with an associated integrated circuit time at which said signal element is generated, wherein said signal element is forwarded to said second simulator when said second simulator reaches said associated integrated circuit time.

16. The computer readable medium of claim 15, further comprising:
suspending an operation of said second simulator if said signal element is not generated when said second simulator reaches said integrated circuit time.

17. A master scheduler enabling functional verification of an integrated circuit, said integrated circuit comprising a plurality of modules, wherein each of said plurality of modules can be simulated by a corresponding one of a plurality of heterogenous simulators, said master scheduler comprising:
means for receiving data representing assignment of each of said plurality of modules to a corresponding one said plurality of heterogenous simulators and an interconnection of said plurality of modules;
means for receiving a signal element from a first simulator comprised in said plurality of heterogenous simulators, wherein said signal element is generated by simulating a corresponding module assigned to said first simulator; and
means for forwarding said signal element to a second simulator according to said interconnection of said plurality of modules, wherein said second simulator is comprised in said plurality of heterogenous simulators.

18. The master scheduler of claim 17, wherein said interconnection specifies a specific module to which an output signal generated by an another module is to be provided, wherein said specific module and said another module are comprised in said plurality of modules.

19. The master scheduler of claim 17, wherein said plurality of heterogenous simulators comprise a VHDL simulator, a Verilog simulator and an analog simulator.

20. The master scheduler of claim 17, further comprising:
means for determining a step time; and
means for suspending the operation of each of said plurality of heterogenous simulators after simulating said step time.

21. The master scheduler of claim 20, further comprising means for resuming operation of all of said plurality of heterogenous simulators after all of said plurality of heterogenous simulators complete simulating said step time and after said forwarding.

22. The master scheduler of claim 21, wherein said step time comprises a highest common factor of a longest time taken by each of said plurality of modules to generate a corresponding output value based on a corresponding set of input values.

23. The master scheduler of claim 17, further comprising:
means for storing said signal element along with an associated integrated circuit time at which said signal element is generated, wherein said signal element is forwarded to said second simulator when said second simulator reaches said associated integrated circuit time.

24. The master scheduler of claim 23, further comprising:
means for suspending an operation of said second simulator if said signal element is not generated when said second simulator reaches said integrated circuit time.

25. A master scheduler enabling functional verification of an integrated circuit, said integrated circuit comprising a plurality of modules, wherein each of said plurality of modules can be simulated by a corresponding one of a plurality of heterogenous simulators, said master scheduler comprising:
a memory storing data representing assignment of each of said plurality of modules to a corresponding one said plurality of heterogenous simulators and an interconnection of said plurality of modules;
a simulator interface receiving a signal element from a first simulator comprised in said plurality of heterogenous simulators, wherein said signal element is generated by simulating a corresponding module assigned to said first simulator; and
a processing unit forwarding said signal element to a second simulator according to said interconnection of said plurality of modules, wherein said second simulator is comprised in said plurality of heterogenous simulators.

26. The master scheduler of claim 25, wherein said interconnection specifies a specific module to which an output signal generated by an another module is to be provided, wherein said specific module and said another module are comprised in said plurality of modules.

27. The master scheduler of claim 25, wherein said plurality of heterogenous simulators comprise a VHDL simulator, a Verilog simulator and an analog simulator.

28. The master scheduler of claim 25, wherein said processing unit causes a suspension of operation of each of said plurality of heterogenous simulators after simulating a step time.

29. The master scheduler of claim 28, wherein said processing unit resumes operation of all of said plurality of heterogenous simulators after all of said plurality of heterogenous simulators complete simulating said step time and after forwarding said signal element.

30. The master scheduler of claim 29, wherein said step time comprises a highest common factor of a longest time taken by each of said plurality of modules to generate a corresponding output value based on a corresponding set of input values.

31. The master scheduler of claim 25, wherein said memory stores said signal element along with an associated integrated circuit time at which said signal element is generated, wherein said processing unit forwards said signal element to said second simulator when said second simulator reaches said associated integrated circuit time.

32. The master scheduler of claim 31, wherein said processing unit suspends an operation of said second simulator if said signal element is not generated when said second simulator reaches said integrated circuit time.
